(19) United States
(12) Patent Application Publication
(10) Pub. No.: US 2022/0101399 A1
(43) Pub. Date: Mar. 31, 2022

(54) Remote Customer Assistance Using a Secondary Device Screen

(71) Applicant: Wells Fargo Bank, N.A., San Francisco, CA (US)

(72) Inventor: Kourtney Eidam, Marietta, GA (US)

(21) Appl. No.: 15/390,116

(22) Filed: Dec. 23, 2016

(51) Int. Cl. G06Q 30/06; H04L 29/06; H04L 12/58

(52) U.S. Cl. CPC G06Q 30/0613; H04L 51/24; H04L 65/1063

(57) ABSTRACT

Assistance is provided to a user of an electronic computing device. A request for assistance is received from a primary electronic computing device of a customer. An item for which the assistance is requested is identified. A secondary electronic computing device is identified that is associated with the customer of the primary electronic computing device. A version of the item is sent to the secondary electronic computing device. Interaction with the item is allowed on the secondary electronic computing device.

### BACKGROUND

Customers of a business often need to fill out forms and other documents. Sometimes the forms and documents are straightforward and a customer can complete the form without help. Other times a form or document may be confusing, and the customer may have difficulty understanding how to fill out the form or document.

Customer service representatives of the business can help the customer when the customer experiences difficulty with a form or document. When the customer service representative is at the same physical location of the customer, the customer service representative can see where the difficulty is and help the customer. When the customer service representative and the customer are at different physical locations, help can be more difficult to provide.

### SUMMARY

Embodiments of the disclosure are directed to a method for providing assistance to a user of an electronic computing device. The method comprises: receiving a request for assistance from a primary electronic computing device of a customer; identifying an item for which the assistance is requested; identifying a secondary electronic computing device that is associated with the customer of the primary electronic computing device; sending a version of the item to the secondary electronic computing device; and allowing for interaction with the item on the secondary electronic computing device.

In another aspect, a method implemented on a server computer for providing assistance to a customer comprises: on the server computer, receiving a request for assistance from a primary electronic computing device of the customer, the primary electronic computing device being a desktop computer, a laptop computer or a tablet computer; sending a notification to the primary electronic computing device requesting permission to interact with the primary electronic computing device; receiving from the primary electronic computing device permission to interact with the primary electronic computing device; identifying a document from the primary electronic computing device for which the assistance is requested; identifying a mobile electronic computing device that is associated with the primary electronic computing device; and sending a version of the document to the mobile electronic computing device.

In yet another aspect, a server computer comprises: a processing unit; and system memory, the system memory including instructions which, when executed by the processing unit, cause the server computer to: receive a request for assistance from a primary electronic computing device, the primary electronic computing device being a desktop computer, a laptop computer or a tablet computer; send a notification to the primary electronic computing device requesting permission to interact with the primary electronic computing device and with a secondary electronic computing device; receive permission to interact from the primary electronic computing device; identify a document from the primary electronic computing device for which the assistance is requested; identify a mobile electronic computing device that is registered as a secondary electronic device; send a version of the document to the mobile electronic computing device; identify an area of the document for which the assistance is required; and allow an interaction with the area of the document on the mobile electronic computing device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that can support remote customer assistance using a secondary device screen.

FIG. 2 shows example modules of a financial institution server computer of FIG. 1.

FIG. 3 shows an example user interface for a digital dashboard that can be rendered on the customer service electronic computing device of FIG. 1.

FIG. 4 shows a method implemented on the financial institution server computer for assisting a customer using the secondary electronic computing device of FIG. 1.

FIG. 5 shows example physical components of the financial institution server computer of FIG. 1.

### DETAILED DESCRIPTION

The present disclosure is directed to systems and methods for providing remote assistance to a customer of a business.

In some non-limiting examples, the customer can identify and register one or more secondary electronic computing devices with the business. When the customer is interacting with the business using a primary electronic computing device, and the customer is having difficulty understanding an online tool, section of a website, form or document, a customer service representative can interact with the customer using one of the secondary electronic computing devices. The online tool (for example bill pay or money transfer), form or document can be displayed on one of the secondary electronic computing devices, and the customer service representative can interact with one or more areas of the online tool, form or document using the secondary electronic computing device.

Providing customer assistance using the secondary electronic computing device can be more efficient than providing help using the primary electronic computing device. Providing help using the primary electronic computing device can be problematic because a video screen showing the customer service representative can obscure the area of the document for which assistance may be needed. In addition, providing customer assistance on the primary screen can cause legal issues if the customer service representative were to check a box on the document or make other changes to the document for the customer.

In this disclosure, the use of the secondary electronic computing device is described for a customer of a financial institution, such as a bank. Forms or documents described can include, but are not limited to, loan applications, mortgage applications, checking account applications and similar types of documents. However, the use of the secondary electronic computing device can also be used for other types of businesses.

In an example implementation, a customer of a financial institution can access a website of the financial institution using a desktop computer. The website permits the customer to access a plurality of financial institution services, including bill pay, car insurance and applying for a loan online. For example, when the customer applies for the loan, a server computer associated with the website can send a loan application form to the desktop computer for display on a display screen of the desktop computer. When the document is displayed, one or more customer service icons can also be displayed with the document. For example, one of the icons can permit the customer to initiate an online chat with a customer service representative of the financial institution.

During the course of filling out the loan application form, the customer may have a question regarding one or more fields on the form. In this example, the customer selects the icon for an online chat, and the online chat is initiated. In some implementations, an image of the customer service representative is displayed on the desktop computer and the customer service representative can proceed with the online chat. In other implementations, the online chat can proceed without the image of the customer service representative being displayed.

When the customer selects the icon for the online chat, a contextually specific alert is sent to a customer service representative of the financial institution. The customer service representative can then see the display screen of the customer's desktop computer. For example, the display screen can be displayed on a customer service digital dashboard. The customer service representative can see a specific section of a website the customer is accessing or a type of tool or document the customer has accessed. In this example, the customer service representative can view the loan type (for example prequalifying or refinancing a mortgage), the loan application form and customer information, such as a name, financial history and related data. Additionally, the customer service representative can identify a section within the form that the customer is viewing and may be able to identify the customer's issue with the form.

The customer service representative can also determine that the customer has registered a secondary electronic computing device. As discussed in more detail later herein, the customer can register one or more secondary electronic computing devices that can be associated with the customer's primary electronic computing device, the desktop computer. For example, one secondary electronic computing device can be the customer's smartphone.

The customer service representative can send a push notification to the customer's smartphone and request that the online chat be switched to the customer's smartphone. In some implementations, the push notification can request that the customer's smartphone join the online chat with the customer's desktop computer. For example, when both the customer's smartphone and desktop computer are available, the video chat can occur on the customer's desktop computer and the customer service representative can also access the customer's smartphone. In addition, the customer service representative can switch an online chat from a primary screen to a secondary screen and back to the primary screen as the need arises.

When the customer accepts the push notification, the server computer can send a version of the form that the customer is viewing to the customer's smartphone. The version of the form can be a blank form similar to what the customer is viewing on the customer's desktop computer or the version of the form can be an actual copy of the form that the customer is viewing on the customer's desktop computer. In an example implementation, the customer service representative can view the form displayed on the customer's desktop and mirror the form back to the customer's smartphone or other registered secondary device.

When the version of the form is displayed on the customer's smartphone, the customer service representative can interact with the form on the customer's smartphone. For example, the customer service representative can identify, select or highlight certain areas of the form to help the customer locate those areas. The customer service representative can also enter data into certain areas of the form as an example for the customer. However, when the certain areas of the form are highlighted and when the customer service representative enters data into the certain areas of the form, nothing changes on the form displayed on the customer's primary device, the desktop computer. Instead, the changes made to the form on the customer's smartphone are made to help the customer see the changes that need to be made. The customer can then make the appropriate changes on the form displayed on the customer's desktop computer.

In addition to or in lieu of an online chat, the customer service representative can initiate a video chat or can launch a how-to-video. With a video chat, an image of the customer service representative can be displayed on the customer's desktop computer or smartphone. The how-to-video can be launched on the customer's smartphone and can show the customer how to fill out the form displayed on the customer's desktop computer.

In addition to providing help with forms and documents, the systems and methods can provide functionality in other areas. For example, the customer service representative can launch a video of the recommended product or service, for example a commercial video, based on the interaction with or inquiry from the customer. In other example, the customer can have an online appointment with a customer service representative such as a loan officer, a mortgage officer or a stock broker. The customer service representative can have relevant information regarding the customer displayed on a customer service representative's digital dashboard. For example, the customer service representative may have information that the customer is pre-qualified for a mortgage or has a car loan with the financial institution. The customer service representative can interact with pertinent documents on the customer's smartphone. Other uses can include providing product or service information to the customer on a secondary screen.

The customer service representative can also send an authentication mechanism to the customer's smartphone. For example, when the customer needs to sign a document, the customer service representative can push an electronic signature pad to the customer's touch screen smartphone or tablet computer. The customer can electronically sign the document using the signature pad. In some implementations, instead of a signature pad another authentication device can be used. For example, the customer service representative can push a fingerprint scanner, a retinal scanner or some other biometric authentication mechanism to the customer's smartphone.

The customer service digital dashboard can permit the customer service representative to send a plurality of push notifications to the customer. For example, one push notification can be for a video chat with the customer. Another push notification can result in sending a video to the customer that can provide a tutorial on the form. Also, the customer service representative can send a push notification immediately upon reception of a chat alert or the customer service representative can send the push notification after a conversation is initiated with the customer.

The systems and methods also permit the customer to select preferences for an online conversation with the customer service representative. For example, the customer can select a preference for a two-way video chat. When the customer does not want be seen by the customer service representative, the customer can select a one-way video chat, whereby only an image on the customer service representative is shown on the customer's display screen but an image of the customer is not displayed to the customer service representative.

In addition, multiple levels of consent may be required. For example, the customer may be required to opt-in to the secondary device service and register one or more secondary devices. The customer needs to accept an online chat service and the customer needs to accept the push notification. The customer may also be required to provide consent for aspects of the online chat session, such as whether the session is a video chat, whether the video chat is one way or two ways, etc.

In some implementations, instead of having a registered secondary device, the primary and secondary devices can be paired. For example, a Bluetooth session can be set up between the desktop computer and the customer's smartphone. The customer service representative can see the pairing and inquire as to whether the customer service representative wishes to conduct an online chat using the paired device. When consent is received, the paired device can be used as the secondary device.

The systems and methods disclosed herein are directed to a computer technology that can improve an efficiency of an interactive customer assistance session. A customer can view a document accessed via a server computer at a primary customer electronic computing device and receive help in filling out the document at a secondary customer electronic computing device. A customer service representative can cause a version of the document to be rendered on the secondary electronic computing device and provide assistance to the customer at the secondary electronic computing device. At the same time the customer can still have the document that is to be submitted open on the primary customer electronic computing device. The customer service representative can highlight or make changes to the version of the document at the secondary electronic computing device without affecting or obscuring any part of the document that is to be submitted on the primary electronic computing device. This provides a more efficient method of helping the customer and avoids any legal issues that could be caused if the customer service representative made changes to the document on the primary customer electronic computing device.

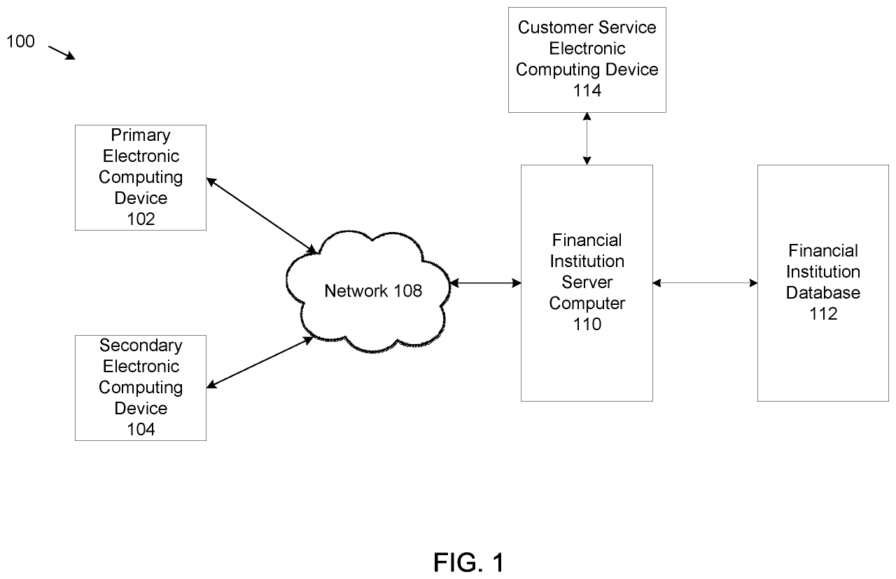

FIG. 1 shows an example system 100 that can support remote customer assistance using a secondary device screen. System 100 includes a primary electronic computing device 102, a secondary electronic computing device 104, a network 106, a financial institution server computer 110 and a financial institution database 112. More, fewer of different components can be used.

The example primary electronic computing device 102 is an electronic computing device that permits a connection to a webpage hosted by a financial institution server computer and that permits editing of documents displayed via the webpage. The primary electronic computing device 102 can run a financial application software application that can permit the online connection to the webpage. The primary electronic computing device 102 can be a desktop computer, a laptop computer or a mobile electronic computing device, such as a tablet computer or smartphone.

The example secondary electronic computing device 104 is an electronic computing device that can be registered at the financial institution server computer by a user of primary electronic computing device 102. The secondary electronic computing device 104 can permit a secondary connection to financial institution server computer 110 and can provide an alternate or additional device to display forms or documents from the financial institution server computer. The user of primary electronic computing device 102 and secondary electronic computing device 104 is typically a customer of a financial institution associated with financial institution server computer 110. The secondary electronic computing device 104 is typically a mobile electronic computing device of the customer, such as a smartphone or a tablet computer.

The example network 108 is a computer network such as the Internet. The user of primary electronic computing device 102 can access financial institution server computer 110 across network 108. Forms and documents from financial institution server computer 110 can be sent across network 108 and rendered on primary electronic computing device 102 and secondary electronic computing device 104.

The example financial institution server computer 110 is a server computer of a financial institution such as bank. The user of primary electronic computing device 102 and secondary electronic computing device 104 can have one or more financial accounts at financial institution server computer 110. The user can login to financial institution server computer 110 from primary electronic computing device 102 and access forms and documents that can be rendered on primary electronic computing device 102. As discussed earlier herein, the forms and documents can also be rendered on secondary electronic computing device 104. The user can also login to financial institution server computer 110 from secondary electronic computing device 104. Financial institution server computer 110 can comprise more than one physical server computer.

The example financial institution database 112 is a database associated with financial institution server computer 110. The financial institution database 112 can store financial records of customers of the financial institution associated with financial institution server computer 110. Forms and documents of the financial institution can also be stored on financial institution database 112. Financial institution database 112 can comprise more than one physical database.

The example customer service electronic computing device 114 is an electronic computing device of a customer service representative of the financial institution. The customer service representative can login to financial institution server computer 110, display a digital dashboard on the customer service electronic computing device 114 and view customer documents on the customer service electronic computing device 114. The customer service electronic computing device 114 is typically a desktop computer, although other types of electronic computing devices can be used.

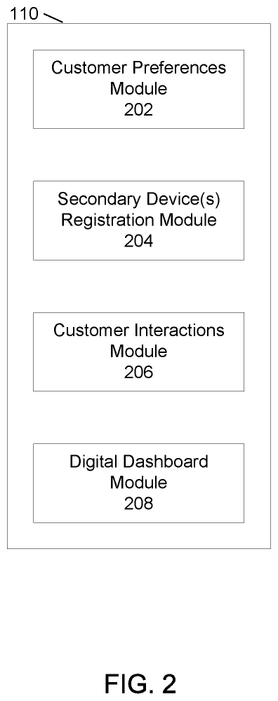

FIG. 2 shows example modules of financial institution server computer 110. The example modules include a customer preferences module 202, a secondary device(s) registration module 204, a customer interactions module 206 and a digital dashboard module 208. More, fewer or different modules are possible.

The example customer preferences module 202 processes customer preferences—regarding a communication session with the financial institution server computer 110. Example customer preferences can include whether to consent to have the customer's information shared with the customer service representative, to select a preference of a secondary electronic computing device to use, to have a video chat or an online chat that does not use video, to have a one-way video chat or a two-way video chat, to prefer how-to-videos rather than a mirrored document and to consent to a biometric authentication method. Other customer preferences are possible.

The example secondary device(s) registration module 204 processes registrations of one or more secondary electronic computing devices of the customer. During a registration process the customer can identify one or more secondary electronic devices to use. Secondary devices are typically mobile electronic computing devices, but no not need to be. Example secondary electronic computing devices can include smartphones, tablet computers, laptop computers and desktop computers.

The example customer interactions module 206 processes interactions between the customer service representative and the customer. Interactions processed by the customer interactions module 206 can include receiving requests from the customer for an online chat, sending a push notification to the customer, viewing a customer's document from the customer's primary electronic computing device, mirroring the customer's document on a registered secondary electronic computing device of the customer, highlighting or selecting one more sections of the customer's document on the customer's secondary electronic computing device, pushing an authentication mechanism to the customer's secondary electronic computing device and processing authentication inputs from the customer. Other customer interactions are possible.

The example digital dashboard module 208 renders a digital dashboard on the customer service electronic computing device 114. The digital dashboard can permit the customer service representative to provide one or more push notifications to the customer in response to a customer request for an online chat. The digital dashboard can also permit the customer to access financial account records for the customer, a personal profile for the customer, a list of secondary devices registered by the customer, a record of customer preferences regarding the use of a secondary device and to send a version of the document the customer is viewing to a preferred secondary device of the customer. Other functionality for the digital dashboard is possible.

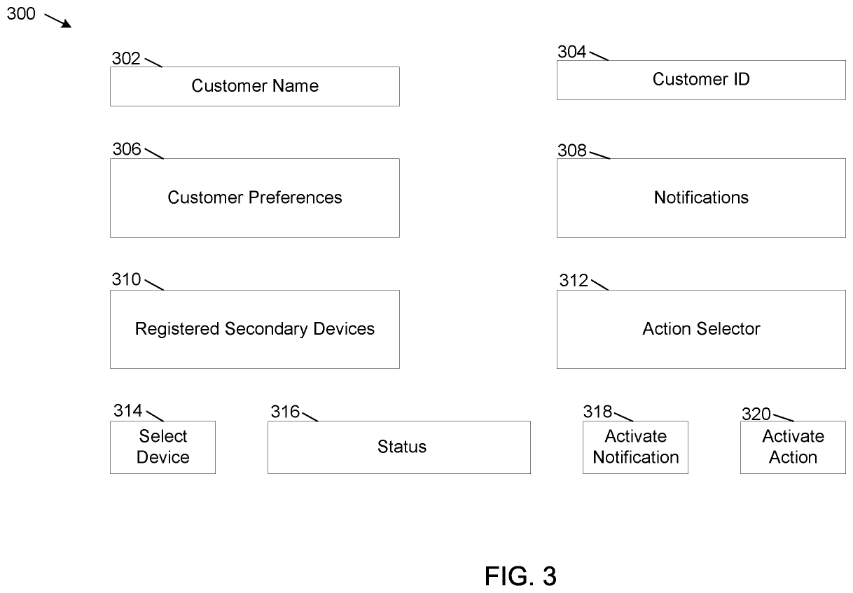

FIG. 3 is a user interface for an example digital dashboard 300 for a customer service representative. The digital dashboard 300 can be displayed on a display screen of the customer service electronic computing device 114.

The example digital dashboard 300 includes a customer name 302 text box and a customer ID 304 text box. In an example implementation, when the customer clicks on a live chat icon on the customer's primary electronic computing device 102, financial institution server computer 110 causes the customer's name to be displayed in the customer name 302 text box and an identifier for the customer to be displayed in the customer ID 304 text box.

The customer identifier can be a unique identifier for the customer, for example a customer ID or a financial account number at the financial institution. In some implementations, the customer service representative can click on the customer ID 304 text box and cause additional profile information for the customer to be displayed. The profile information (not shown) can include the customer's marital status, age of the customer's children, the customer's employer, any customer mortgages or personal loans the customer may have at the financial institution and other profile information.

The digital dashboard 300 also includes a customer preferences 306 list box, a notifications 308 list box, a registered secondary devices 310 list box, an action selector 312 list box, a select device 314 control button, a status 316 display box, an activate notification 318 control button and an activate action 320 control button. More, fewer or different items may be used on the digital dashboard 300.

The example customer preferences 306 list box provides a list of preferences entered by the customer. The customer can enter the preferences with financial institution server computer 110 via a software application on the customer's primary electronic computing device 102. Example customer preferences can include a selection as to a one-way or two-way video chat, and permission preferences such as a degree to which the customer permits the customer service representative to view customer data, to view customer data on a form or online document and whether to mirror customer data to the secondary electronic computing device.

The example notifications 308 list box lists different types of notifications that the customer service representative can use. Example notifications can include notifications for an online chat that does not include video, a one-way video-chat and a two-way video chat. Other notifications can include a notification for a video tutorial. To activate a specific notification, the customer service representative can highlight a notification on the notifications 308 list box and then click the activate notification 318 control button.

The example registered secondary devices 310 list box provides a list of secondary electronic computing devices registered by the customer at financial institution server computer 110. Examples of secondary devices can include a smartphone phone and a tablet computer. When the customer enters a preferred secondary electronic computing device to use, the preferred secondary electronic computing device can be highlighted, for example displayed in bold letters, in the registered secondary devices 310 list box. The customer service representative can select a secondary electronic computing device to use by clicking on the secondary electronic computing device in the registered secondary devices 310 list box and then clicking the select device 314 control button.

The example action selector 312 list box displays a list of actions that the customer service representative can take. Example actions can include viewing the document on the customer's primary electronic computing device, sending a mirrored version of the document to the customer's selected secondary electronic computing device, sending a blank copy of the document to the customer's selected secondary electronic computing device, viewing an editable version of the document displayed on the customer's selected secondary electronic computing device (permitting the customer service representative to highlight and make changes to the document), sending a how-to video to the customer's selected secondary electronic computing device, initiating a non-video online chat with the customer, initiating a one-way video chat with the customer, initiating a two-way video chat with the customer, and other actions. The customer service representative can activate the selected action by highlighting the action in the action selector 312 list box and then clicking on the activate action 320 control button.

The example status 316 display box can display a current status of the communication between the customer service representative and the customer. For example, a status could be “two-way video chat with secondary device” or “view document on primary device” or “edit document on secondary device.” A plurality of other statuses is possible.

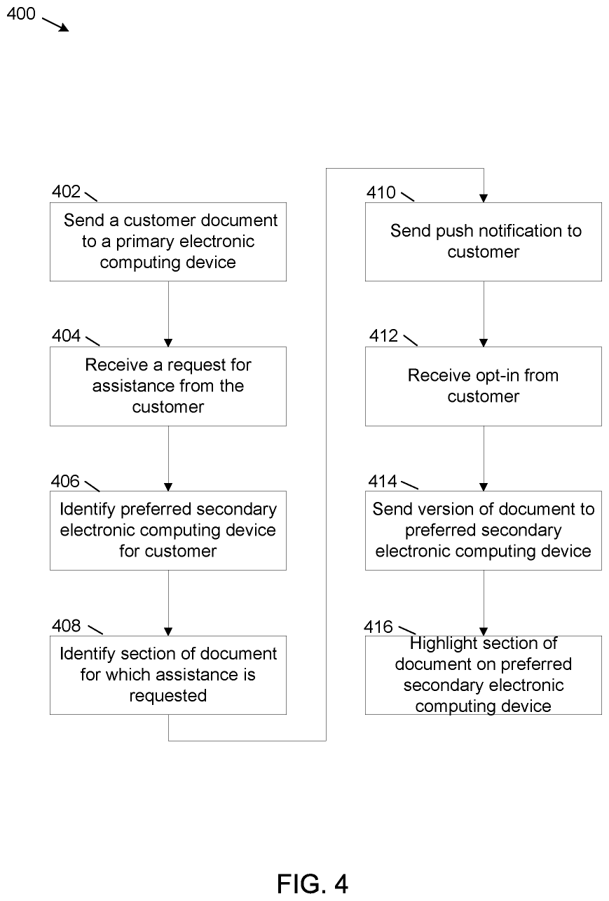

FIG. 4 shows a flowchart of an example method 400 for assisting a customer using a secondary electronic computing device.

At operation 402, as a result of a customer accessing a document on a webpage of a financial institution, a server computer, sends a copy of the document to the customer's primary electronic computing device. For method 400, the server computer is financial institution server computer 110 and the customer's primary electronic computing device is a desktop computer.

At operation 404, a request for assistance is received from the customer. In an example implementation, the customer can receive the request for assistance by clicking on a chat icon displayed with the document on a display screen of the customer's desktop computer.

At operation 406, a customer service representative view can identify a preferred registered secondary electronic computing device for the customer. The customer may have registered more than one secondary electronic computing device and may have designated one of the secondary electronic computing devices as a preferred device.

At operation 408, the customer service representative identifies a section of the customer's document for which assistance is requested. The customer service representative can see the document that the customer is viewing via a digital dashboard and may be able to determine a section of the document for which the customer needs help.

At operation 410, the customer service representative can send a push notification to the preferred registered secondary electronic computing device. The push notification can request an opt-in from the customer to permit a communication session between the customer server representative and the customer at the preferred registered secondary electronic computing device. The push notification can also request a specific type of communication session, such as an online chat that does not include video, a one-way video chat in which the customer can see an image of the customer service representative but in which the customer service representative cannot see a live image of the customer and a two-way video chat in which both the customer and the customer service representative can see images of each other. The customer service representative can determine which type of communication is appropriate to request based on the section of the document that the customer is viewing and a determination of what type of communication may be best to help the customer with the section of the document.

At operation 412, an opt-in by the customer is received at financial institution server computer 110. The opt-in comprises a granting of permission by the customer to accept the communication session proposed in the push notification.

At operation 414, the customer service representative sends a version of the document to the preferred secondary electronic computing device. The version of the document can be a mirrored image of the document that the customer is viewing or it can be a blank copy of the document. When the version of the document is the mirrored image of the document that the customer is viewing, any changes that the customer may have previously made to the document on the customer's desktop computer are mirrored to the customer's secondary electronic computing device.

At operation 416, the customer service representative highlights a section of the document for which the customer is having difficulty. For example, the customer service representative may highlight a checkbox on the document that the customer needs to check or the customer service representative can highlight a line of the document that the customer needs to sign. Alternatively, or in addition, the customer service representative can send a video to the secondary electronic computing device to provide a tutorial for filling out the document. The customer service representative can also send an authentication mechanism, such as an electronic signature pad or a biometric authentication mechanism. Other interactions between the customer service representative and the customer are possible.

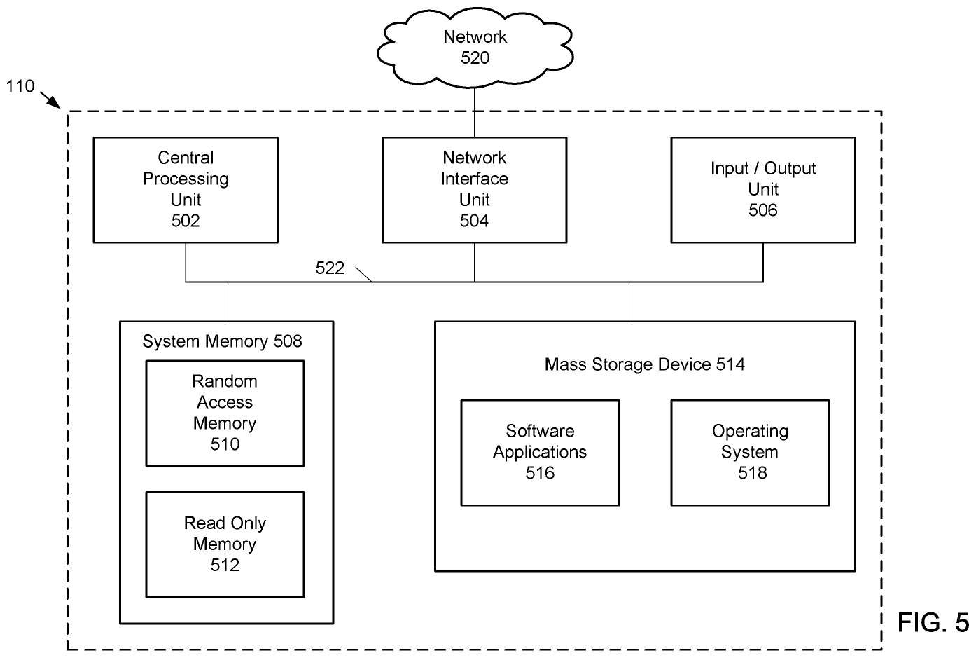

As illustrated in the example of FIG. 5, financial institution server computer 110 includes at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system that contains the basic routines that help to transfer information between elements within the financial institution server computer 110, such as during startup, is stored in the ROM 512. The financial institution server computer 110 further includes a mass storage device 514. The mass storage device 514 is able to store software instructions and data. Some or all of the components of the financial institution server computer 110 can also be included in primary electronic computing device 102.

The mass storage device 514 is connected to the CPU 502 through a mass storage controller (not shown) connected to the system bus 522. The mass storage device 514 and its associated computer-readable data storage media provide non-volatile, non-transitory storage for the financial institution server computer 110. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computer 110.

According to various embodiments of the invention, the financial institution server computer 110 may operate in a networked environment using logical connections to remote network devices through the network 520, such as a wireless network, the Internet, or another type of network. The financial institution server computer 110 may connect to the network 520 through a network interface unit 504 connected to the system bus 522. It should be appreciated that the network interface unit 504 may also be utilized to connect to other types of networks and remote computing systems. The financial institution server computer 110 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the financial institution server computer 110 can store software instructions and data. The software instructions include an operating system 518 suitable for controlling the operation of the financial institution server computer 110. The mass storage device 514 and/or the RAM 510 also store software instructions, that when executed by the CPU 502, cause the financial institution server computer 110 to provide the functionality of the financial institution server computer 110 discussed in this document. For example, the mass storage device 514 and/or the RAM 510 can store software instructions that, when executed by the CPU 502, cause the financial institution server computer 110 to display received data on the display screen of the financial institution server computer 110.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for providing assistance to a user of an electronic computing device, the method comprising:
receiving, from a primary electronic computing device of a customer, a request for assistance from a customer service representative, wherein the request for assistance is initiated upon receipt of a selection by the customer of a customer assistance option on a customer service user interface display associated with the primary electronic computing device;
initiating a communication session with the customer on the primary electronic computing device between the customer and the customer service representative, wherein the communication session includes an interaction between the customer and the customer service representative using a customer service assistance application, the interaction including video chat;
identifying a document for which the assistance from a customer service representative is requested;
identifying a secondary electronic computing device of the customer;
sending a notification to the primary electronic computing device requesting permission to switch the communication session from the primary electronic computing device to the secondary electronic computing device;
receiving permission to switch the communication session from the primary electronic computing device to the secondary electronic computing device;
upon receiving permission to switch the communication session from the primary electronic computing device to the secondary electronic computing device:
switching the communication session from the primary electronic computing device to the secondary electronic computing device;
sending a copy of the document and the customer service user interface display to the secondary electronic computing device while continuing to display the document on the primary electronic computing device; and
allowing for interaction by the customer and the customer service representative with the copy of the document on the secondary electronic computing device, the interaction including allowing the customer service representative to highlight and change the copy of the document on the secondary electronic computing device; and
sending a digital dashboard to a customer service electronic computing device of the customer service representative, the digital dashboard including controls to facilitate the interacting with the copy of the document on the secondary electronic computing device, with the controls including:
a first control to allow the customer service representative to send a notification to the customer to initiate the video chat;
a second control to allow the customer service representative to send the copy of the document to the secondary electronic computing device; and
a third control to allow the customer service representative to access financial information associated with the customer.

2. (canceled)

3. The method of claim 1, wherein the permission permits the interaction with the document on the secondary electronic computing device.

4. The method of claim 1, further comprising receiving a registration of the secondary electronic computing device.

5. The method of claim 1, further comprising receiving permissions from the user regarding personal preferences of the customer regarding a type of communication used at the secondary electronic computing device.

6. The method of claim 5, wherein the type of communication can be one of a one-way video chat or a two-way video chat.

7. The method of claim 5, further comprising receiving permissions from the customer regarding personal preferences of the customer regarding a type of communication used at the primary electronic computing device.

8. The method of claim 1, further comprising receiving multiple consents from the customer regarding the interaction with the document at the secondary electronic computing device.

9. The method of claim 1, further comprising:
sending an authentication mechanism to the secondary electronic computing device; and
receiving authentication information from the secondary electronic computing device to authenticate the customer at the secondary electronic computing device.

10. The method of claim 1, further comprising:
sending an electronic signature pad to the secondary electronic computing device; and
receiving an electronic signature from the customer.

11. (canceled)

12. The method of claim 1, further comprising:
determining that the primary electronic computing device is paired to the secondary electronic computing device; and
communicating with the secondary electronic computing device using a pairing between the primary electronic computing device and the secondary electronic computing device.

13. The method of claim 1, wherein the primary electronic computing device is a desktop computer or a laptop computer and the secondary electronic computing device is a mobile electronic computing device.

14-20. (canceled)
